(19) United States
(12) Patent Application Publication
(10) Pub. No.: US 2026/0323543 A1
(43) Pub. Date: Oct. 15, 2026

(54) AUTOMATIC GAIN CONTROL WITH RECEIVER DESENSITIZATION FOR INTERFERENCE IN PACKET RECEPTION

(71) Applicant: Morse Micro Pty. Ltd., Surry Hills NSW (AU)

(72) Inventor: Mohammed Mohammed, Surry Hills NSW (AU)

(21) Appl. No.: 19/380,675

(22) Filed: Nov. 5, 2025

(30) Foreign Application Priority Data
Apr. 14, 2025 (AU) 2025901282

(51) Int. Cl. H04W 52/52; H04W 24/08; H04W 52/24; H04W 52/36

(52) U.S. Cl. CPC H04W 52/52; H04W 24/08; H04W 52/243; H04W 52/367

(57) ABSTRACT

Systems and techniques are provided for automatic gain control (AGC) in a wireless device. A method includes identifying a signal received on a wireless medium using a first gain of a receiver as an interference signal, based on a power level of the signal exceeding a configured AGC threshold. In response to the identification, a second gain less than the first gain is configured to thereby desense the receiver. An indication of packet arrival is detected using the second gain and within a configured duration of a monitoring period. In response to the indication of packet arrival, gain information of the receiver is adjusted to obtain a third gain less than the second gain. Using the receiver configured with the third gain, a packet corresponding to the indication of packet arrival is received.

### CROSS-REFERENCE TO RELATED APPLICATIONS

This application claims the benefit of Australian Provisional Patent Application No. 2025901282, filed on Apr. 14, 2025, which is hereby incorporated by reference, in its entirety and for all purposes.

### FIELD

The present disclosure generally relates to wireless communications. For example, aspects of the present disclosure are related to systems and techniques for automatic gain control (AGC) with a desensitization mechanism configured to dynamically adjust a receiver gain based on a detected interference power level.

### BACKGROUND

Automatic Gain Control (AGC) is a technique used in receivers to automatically adjust amplifier gain, thereby maintaining a consistent signal amplitude for subsequent processing stages of the receiver. For example, in a wireless receiver, the AGC can be used to adjust one or more amplifier gains in the receive chain so that the signal presented to a downstream stage, such as an analog-to-digital converter (ADC), is maintained at a target amplitude. By adjusting the receiver's gain, AGC isolates downstream stages from large input power variations caused by factors such as path loss, fading, shadowing, and interference. Without effective AGC, such signal strength variations can cause degraded receiver performance, increased error rates, or saturation of the ADC. For instance, if an incoming signal is weak, the AGC increases receiver gain to amplify it above the receiver's sensitivity threshold. Conversely, if the signal is strong, the AGC reduces the gain to prevent distortion or ADC saturation.

In packet-based communication systems, such as Wi-Fi and/or other packet-based systems compliant with Institute of Electrical and Electronics Engineers (IEEE) standards, AGC is typically triggered and performed during the reception of the preamble of a packet (e.g., such as during the Short Training Field (STF) of a Wi-Fi packet). The timing of performing AGC during the packet preamble may allow the gain to converge to an optimal or desired level before the data-carrying portion of the packet is demodulated following the packet preamble. However, conventional AGC techniques may struggle in the presence of high-power interference and in environments with both bursty and sustained interference. In such scenarios, an AGC mechanism may falsely trigger on an interference signal rather than a valid packet, based on incorrectly interpreting the interference signal as a valid input signal, which can lead to incorrect gain settings or missed packet detections. While modern AGC implementations often integrate digital signal processing (DSP) to improve speed and accuracy, they can still be susceptible to performance degradation under such dynamic and challenging channel conditions.

When an AGC algorithm continuously responds to relatively high-power interference, at least two significant performance issues can arise. First, the receiver may experience delayed packet detection, as even when the receiver gain is initially set correctly, persistent AGC adjustments triggered by the interference can occupy receiver resources to the point of preventing the receiver from promptly detecting the start of an incoming packet. Second, the receiver may apply incorrect gain settings, as the AGC may incorrectly set the receiver's gain based on the power of the interference rather than the power of the desired signal. A suboptimal gain setting can compromise the reception of the actual packet, particularly when the packet uses a high-order modulation and coding scheme (MCS) that is sensitive to signal quality. Unless these challenges are addressed, the system remains vulnerable to strong interference signals.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for automatic gain control (AGC) in a wireless device. For example, a method for AGC in a wireless device can include: configuring a first gain for a receiver of the wireless device to listen on a wireless medium; identifying a signal received on the wireless medium as an interference signal, wherein the signal is received using the first gain, and wherein the identification is based on a power level of the signal exceeding a configured AGC threshold without the signal including an indication of valid packet reception; configuring, in response to the identification, a second gain for the receiver that is less than the first gain to thereby desense the receiver; detecting an indication of packet arrival using the second gain, wherein the indication of packet arrival is detected within a configured duration of a monitoring period corresponding to the receiver using the second gain; in response to the indication of packet arrival, adjusting gain information of the receiver to obtain a third gain less than the second gain; and receiving, using the receiver configured with the third gain, a packet corresponding to the indication of packet arrival.

In some aspects, the method further comprises starting listening on the wireless medium with a maximum gain for the receiver before configuring the receiver to the first gain.

In some aspects, the first gain is a reduced gain for the receiver determined based on an AGC algorithm.

In some aspects, the second gain is a backoff gain for the receiver determined according to the power level of the signal exceeding the configured AGC threshold without the signal including an indication of valid packet reception.

In some aspects, identifying the signal received on the wireless medium as an interference signal includes: determining an estimated interference power level for the identified interference signal; calculating a value for the second gain based on the estimated interference power level; and lowering the receiver gain from a maximum gain value to the calculated value for the second gain.

In some aspects, the receiver returns to listening on the wireless medium using the first gain in response to an expiration of the configured duration of the monitoring period without an indication of packet arrival.

In some aspects, the method further comprises monitoring the wireless medium for the configured duration of the monitoring period, using the receiver configured with the second gain; and stopping the monitoring in response to expiration of the configured duration, or detection of a valid packet on the wireless medium.

In some aspects, adjusting the gain information of the receiver comprises reducing the first gain by an amount equal to a configured desensitization offset to obtain the second gain.

In some aspects, the configured desensitization offset is 6 decibels (dB).

In some aspects, the configured desensitization offset comprises a dynamically determined value based on one or more signals received by the wireless device.

In some aspects, configuring the second gain maintains an interference power level of the interference signal below the configured AGC threshold.

In some aspects, configuring the second gain for the receiver includes: monitoring the wireless medium for packet arrival based on the receiver maintaining the second gain until expiration of a timer running from a start time of the monitoring, wherein expiration of the timer corresponds to expiration of the configuration duration of the monitoring period.

In some aspects, the method further comprises maintaining the second gain for the receiver until expiration of the configured duration based on a timer running from a start time of the monitoring period, or until detection of the indication of packet arrival.

In some aspects, the method further comprises resetting the gain information of the receiver from the second gain to the first gain in response to the expiration of the configured duration.

In some aspects, the configured duration is a predetermined time duration based on a maximum Transmission Opportunity (TXOP) value configured for communications associated with the wireless device.

In some aspects, detecting the indication of packet arrival is based on detecting a packet preamble sequence within the configured duration of the monitoring period.

In some aspects, the packet preamble sequence is a Short Training Field (STF) of a valid packet.

In another illustrative example, provided is a wireless device operating in a wireless communication network, the wireless device comprising: a receiver configured for reception of one or more packets transmitted on a wireless medium, the receiver including a receive chain with an automatic gain control (AGC); a processor, communicatively coupled to the receiver; and one or more memory banks, communicatively coupled to the processor and storing processor-readable instructions that, when executed by the processor, cause the processor to: configure a first gain for the receiver to listen on the wireless medium; identify a signal received on the wireless medium as an interference signal, wherein the signal is received using the first gain, and wherein the signal is identified as an interference signal based on a power level of the signal exceeding a configured AGC threshold without the signal including an indication of valid packet reception; configure, in response to the identification of the interference signal, a second gain for the receiver that is less than the first gain to thereby desense the receiver; detect an indication of packet arrival using the second gain, wherein the indication of packet arrival is detected within a configured duration of a monitoring period corresponding to the receiver using the second gain; in response to the indication of packet arrival, adjust gain information of the receiver to obtain a third gain less than the second gain; and receive, using the receiver configured with the third gain, a packet corresponding to the indication of packet arrival.

In some aspects, the processor-readable instructions further cause the processor to: start listening on the wireless medium with a maximum gain for the receiver before configuring the receiver to the first gain.

In some aspects, the first gain is a reduced gain for the receiver determined based on an AGC algorithm corresponding to the AGC.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following drawing figures:

FIG. 1 is a block diagram illustrating an exemplary wireless communication network;

FIG. 2A is a block diagram of a wireless communication device that can implement a station (STA) or access point (AP), in accordance with some embodiments;

FIG. 2B is a schematic block diagram of the receiver data flow architecture of the wireless communication device of FIG. 2A, in accordance with some embodiments;

FIG. 2C is a schematic block diagram of a transmitter data flow architecture that can be used to transmit Radio Frequency (RF) signals over a wireless medium, in accordance with some embodiments;

FIG. 3 is a timing diagram illustrating an example of automatic gain control (AGC) operations of a wireless receiver to control amplifier gain associated with detecting incoming packets in the absence of relatively strong interference, in accordance with some examples;

FIG. 4 is a timing diagram illustrating first and second examples of performance degradation for AGC operations of a wireless receiver in the presence of one or more relatively high-power interference signals on the wireless medium, and illustrating a first example of automatic and dynamic receiver desensitization for improved AGC handling of interference during packet reception, in accordance with some examples;

FIG. 5 is a timing diagram illustrating another example of automatic and dynamic receiver desensitization for improved AGC handling of interference during packet reception, using an AGC desense timeout mechanism to reset the receiver gain based on a duration of the receiver desensitization, in accordance with some examples; and

FIG. 6 is a block diagram illustrating an example of a computing system for implementing certain aspects described herein, in accordance with some embodiments.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

### Overview

Aspects of the present invention can be used to provide receiver desensitization for improved AGC handling of interference during packet reception. Receiver desensitization (also referred to interchangeably herein as “receiver desense” and/or “desense”) can refer or correspond to a receiver state in which the receiver gain is deliberately reduced below an optimal sensitivity level to suppress responses to relatively strong, non-packet interference signals. In some embodiments, the invention provides systems and techniques for improved AGC using a desensitization mechanism implemented in a wireless device, such as a wireless receiver. For example, the improved AGC of the invention can be used to robustly differentiate between interference and valid input signals at a wireless receiver, to thereby provide timely packet detection and accurate gain setting even in the presence of strong interference.

In some embodiments, a method for improved AGC by or for a wireless receiver may include setting a receiver gain in the wireless device to listen to the wireless medium, detecting any power level on the wireless medium exceeding an AGC trigger threshold during a listening phase, and determining a presence or absence of a valid packet within a predefined time window upon detecting a power level exceeding the AGC trigger threshold. The receiver identifies an interference signal in the wireless medium when no valid packet is detected within the predefined time window. The gain is accordingly adjusted to desense the receiver so the receiver monitors the wireless medium with this adjusted gain when the receiver identifies the interference signal. The initial gain of the receiver may be set based on an estimated interference power level before packet detection. In some embodiments, the AGC method further estimates an interference power level and adjusts the gain according to the estimated interference power level during the listening phase. The identified interference signal is one or a combination of transient, bursty, and persistent interference.

The gain is adjusted by reducing the gain, for example by 6 dB. The gain is purposely reduced to keep an interference power level of the interference signal below the AGC trigger threshold. Some embodiments of the AGC method maintain the adjusted gain until an AGC desense timeout or until a valid packet is detected. For example, the AGC desense timeout is triggered when no packet is detected within a predetermined duration. The predetermined duration may be based on the maximum Transmission Opportunity (TXOP), which defines the longest allowed uninterrupted transmission time for a device under IEEE 802.11 standards. The AGC method further comprises setting the gain according to a power level of the detected valid packet. In some embodiments, the adjusted gain is reset to the original level once the AGC desense timeout occurs. In some embodiments, the presence of a valid packet is determined when a Short Training Field (STF) is successfully detected. The AGC method further comprises receiving the valid packet upon detecting the STF of the valid packet.

An aspect of the present invention is a wireless device operating in a wireless network. The wireless device comprises a receiver for receiving packets transmitted on a wireless medium, a processor communicatively coupled to the receiver, and one or more memory banks, communicatively coupled to the processor and storing processor readable codes. The processor executes the readable codes to set a gain of an amplifier in the receiver for listening the wireless medium, detect any power level on the wireless medium exceeding an AGC trigger threshold during a listening phase, and upon detecting a power level exceeding the AGC trigger threshold during the listening phase, a presence or absence of a valid packet is determined within a predefined time window. When there is no valid packet detected within the predefined time window after detecting a power level exceeding the AGC trigger threshold, an interference signal is identified and the gain of the amplifier is adjusted accordingly to desense the receiver. The receiver monitors the wireless medium with the adjusted gain when the interference signal is identified.

### EXAMPLE EMBODIMENTS

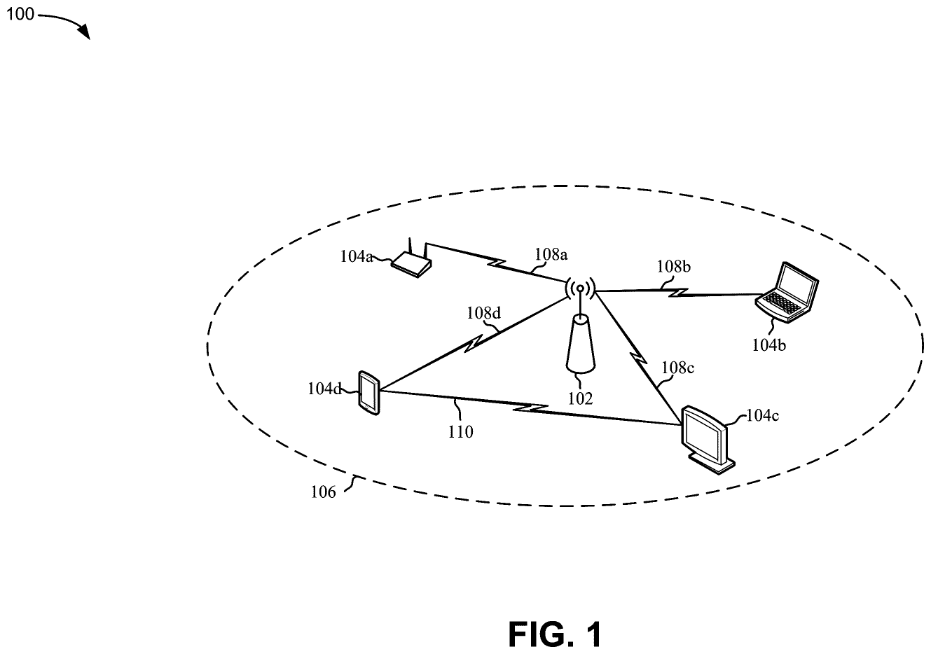

FIG. 1 is a block diagram illustrating an exemplary wireless communication network 100. In some aspects, the wireless communication network 100 can be an example of a Wireless Local Area Network (WLAN). As used herein, a WLAN may be a Wi-Fi network. In some examples, the WLAN 100 can be a network implementing at least one of the IEEE 802.11 family of wireless communication protocol standards (e.g., such as that defined by the IEEE 802.11-2020 specification or amendments thereof including, but not limited to, 802.11ah, 802.11ay, 802.11ax, 802.11az, 802.11ba and 802.11be). The WLAN 100 may include at least one AP 102 and multiple associated STAs 104. For example, the STAs 104 can include a first STA 104a, a second STA 104b, a third STA 104c, a fourth STA 104d, etc. While only one AP 102 is shown, the WLAN network 100 also can include multiple APs 102.

Each of the STAs 104a-104d may be referred to as a Mobile Station (MS), a mobile device, a mobile handset, a wireless handset, an Access Terminal (AT), a User Equipment (UE), a Subscriber Station (SS), and/or a subscriber unit, among other examples. The STAs 104 may represent various devices such as mobile phones, handheld devices, netbooks, computers, tablet computers, laptops, display devices (e.g., TVs, computer monitors, navigation systems, etc.), music or other audio or stereo devices, remote control devices (“remotes”), printers, kitchen or other household appliances, key fobs (e.g., for Passive Keyless Entry and Start (PKES) systems), etc.

A single AP 102 and an associated set of STAs 104a-104d may be referred to as a Basic Service Set (BSS), which is managed by the respective AP 102. FIG. 1 additionally shows an example coverage area 106 of the AP 102, which may represent a Basic Service Area (BSA) of the WLAN 100. The BSS may be identified to users by a Service Set Identifier (SSID), as well as to other devices by a Basic Service Set Identifier (BSSID), which may be a Medium Access Control (MAC) address of the AP 102.

The AP 102 periodically broadcasts beacon frames (“beacons”) including the BSSID to enable any STAs (e.g., such as one or more, or all, of the STAs 104a-104d) within wireless range of the AP 102 to associate or re-associate with the AP 102 to establish a respective communication link 108a-108d (e.g., hereinafter also referred to as a “Wi-Fi link”). For example, the first STA 104a can establish a respective communication link 108a with the AP 102, the second STA 104b can establish a respective communication link 108b with the AP 102, the third STA 104c can establish a respective communication link 108c with the AP 102, the fourth STA 104d can establish a respective communication link 108d with the AP 102, etc. The STAs 104a-104d may additionally use the beacon frames broadcast by AP 102 to maintain the respective communication link 108a-108d with the AP 102. For example, the beacons can include an identification of a primary channel used by the respective AP 102 as well as a timing synchronization function for establishing or maintaining timing synchronization with the AP 102. The AP 102 may provide access to external networks to various STAs in the WLAN via respective communication links 108.

To establish the communication links 108a-108d with an AP 102, each of the respective STAs 104a-104d can perform passive or active scanning operations (“scans”) on frequency channels in one or more frequency bands. For example, to perform passive scanning, each of the STAs 104a-104d listens for beacons that are transmitted by the AP 102 at a periodic time interval referred to as the Target Beacon Transmission Time (TBTT). The TBTT can be measured in Time Units (TUs). In some examples, one TU may be equal to 1024 microseconds (μs). In some examples, the TBTT can have a default value of 102.4 milliseconds (ms). To perform active scanning, each of the STAs 104a-104d can generate and sequentially transmit probe requests on each channel to be scanned and listens for probe responses from the AP 102. Each of the STAs 104a-104d may be configured to identify or select an AP 102 with which to associate (e.g., based on the scanning information obtained through the passive or active scans), and to perform authentication and association operations to establish a respective communication link 108a-108d with the selected AP 102. The AP 102 assigns an Association Identifier (AID) to each of the STAs 104a-104d at the culmination of the association operations, which the AP 102 uses to track the STAs 104a-104d.

In some cases, one or more of the STAs 104a-104d may have the opportunity to select one of many BSSs within range of the STA or to select among multiple APs 102 that together form an Extended Service Set (ESS) including multiple connected BSSs. An extended network station associated with the WLAN 100 may be connected to a wired or wireless distribution system that may allow multiple APs 102 to be connected in an ESS. In some examples, one or more of the STAs 104a-104d can be covered by more than one AP 102 and can associate with different APs 102 at different times for transmissions. After association with an AP 102, one or more of the STAs 104a-104d also may be configured to periodically scan its surroundings to find a more suitable AP with which to associate. For example, a given one of the STAs 104a-104d that is moving away from its associated AP 102 may perform a “roaming” scan to find another AP having more desirable network characteristics (e.g., such as a greater Received Signal Strength Indicator (RSSI), a reduced traffic load, etc.).

In some cases, the STAs 104a-104d may form networks without APs 102 or other equipment other than the STAs 104a-104d themselves. One example of such a network is an ad hoc network. Some examples of an ad hoc network are mesh networks and peer-to-peer (P2P) networks. In some cases, ad hoc networks may be implemented within a larger wireless network In such implementations, while the STAs 104a-104d may be capable of communicating with each other through the AP 102 using the respective communication links 108a-108d, the STAs 104a-104d, the STAs may also communicate directly with each other using direct wireless links 110. In some examples, two STAs may communicate via a direct communication link 110 regardless of whether both STAs 104 are associated with and served by the same AP 102. In such an ad hoc system, one or more of the STAs 104a-104d may assume the role filled by the AP 102 in a BSS. Such a STA may be referred to as a Group Owner (GO) and may coordinate transmissions within the ad hoc network. Examples of direct wireless links 110 can include one or more of Wi-Fi Direct connections, connections established by using a Wi-Fi Tunneled Direct Link Setup (TDLS) link, and other P2P group connections, etc.

The APs 102 and STAs 104a-104d may function and communicate using the respective communication links 108 a-108d according to at least one of the IEEE 802.11 wireless communication protocol standards. These standards define the WLAN radio and baseband protocols for the physical (PHY) and Medium Access Control (MAC) layers. For example, the APs 102 and STAs 104a-104d transmit and receive wireless communications to and from one another in the form of PHY Protocol Data Units (PPDUs) or Physical Layer Convergence Protocol (PLCP) PDUs. The APs 102 and STAs 104a-104d in the WLAN 100 may transmit PPDUs over a licensed or unlicensed spectrum, which may be a portion of spectrum that includes frequency bands traditionally used by Wi-Fi technology, such as the 2.4 GHz band, the 5 GHz band, the 60 GHz band, the 3.6 GHz band, and the sub-1 GHz band. Some implementations of the APs 102 and STAs 104 a-104d described herein also may communicate in other frequency bands, such as the 6 GHz band, which may support both licensed and unlicensed communications. The APs 102 and STAs 104a-104d also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11 standards and specifications may be transmitted over frequency bands that are divided into multiple 20 MHz channels. In such examples, the PPDUs are transmitted over a physical channel having a minimum bandwidth of 20 MHz, although other channel bandwidths are also possible. In some cases, a larger bandwidth channel can be formed using channel bonding, which bonds together multiple channels each of the minimum bandwidth.

Each PPDU is a composite structure that includes a PHY preamble and a payload in the form of a PHY Service Data Unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

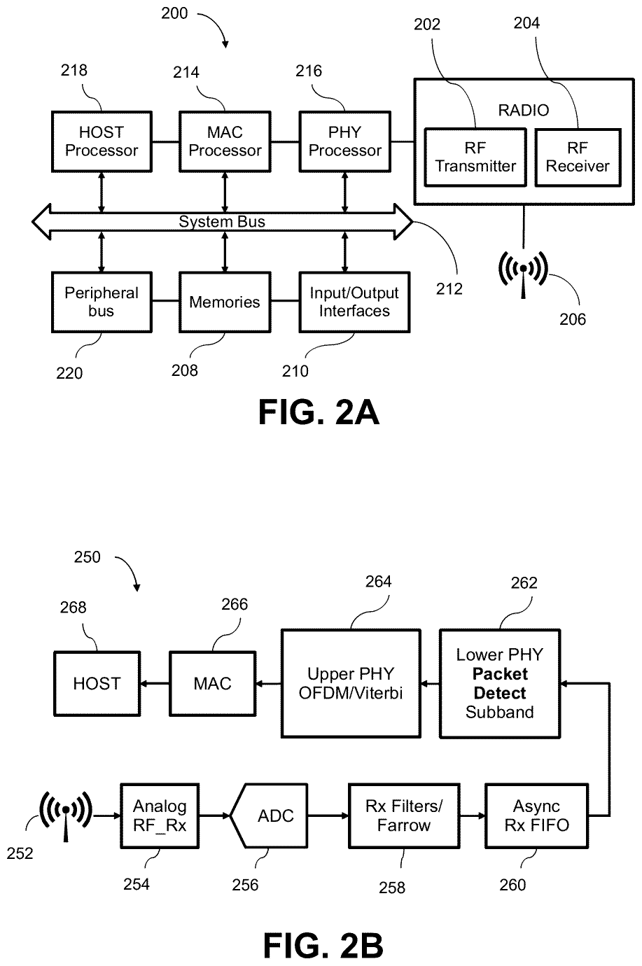

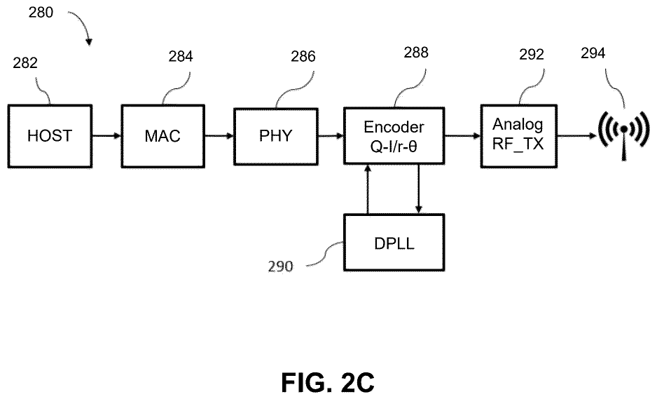

FIG. 2A is a high-level block diagram of an exemplary wireless communication device 200 that can be used to implement a STA or an AP, in some examples. The wireless communication device 200 can include a MAC layer and a PHY layer in accordance with one or more of the IEEE 802.11 standards.

The wireless communication device 200 includes a Radio Frequency (RF) transmitter module 202, an RF receiver module 204, an antenna unit 206, one or more memory banks 208, input and output interfaces 210, and communication bus 212. The RF transmitter module 202 and the RF receiver module 204 include a modem (modulator-demodulator device), which transmits data by modulating one or more carrier wave signals to encode digital information, as well as receives data by demodulating the signal to recreate the original digital information. As illustrated, the wireless communication device 200 further includes a MAC processor 214, a PHY processor 216 and a HOST processor 218. These processors can be any type of Integrated Circuit (IC) including a general-purpose processing unit, an Application Specific Integrated Circuit (ASIC) or Reduced Instruction Set Computer—Five (RISC-V) based ICs, amongst others.

The memory 208 can be used to store software and/or computer-readable instructions, including software or instructions that can be used to implement at least some functions of the MAC layer. For example, each processor included in the wireless communication device 200 (e.g., MAC processor 214, PHY processor 216, HOST processor 218, etc.) executes respective software to implement the functions of the respective communication/application layer.

The PHY processor 216 includes a transmitting signal processing unit and a receiving signal processing unit (not shown) and can be used to manage the interface with the Wireless Medium (WM). The PHY processor 216 operates on PPDUs by exchanging digital samples with the radio module which includes the RF transmitter 202, the RF receiver 204, analog-to-digital converters, and digital filters.

The MAC processor 214 executes MAC level instructions and manages the interface between the application software and the WM, through the PHY processor 216. The MAC processor 214 is responsible for coordinating access to the WM so that the Access Point (AP) and STAs in range can communicate effectively. The MAC processor 214 adds header and tail bytes to units of data provided by the higher levels and sends them to the PHY layer for transmission. The reverse happens when receiving data from the PHY layer. If a frame is received in error, the MAC processor 214 manages the retransmission of the frame.

The HOST processor 218 interfaces with the MAC layer and is responsible for running higher level functionalities of the wireless communication device.

The PHY processor 216, the MAC processor 214, the HOST processor 218, the peripheral bus 220, the memories 208, and the input/output interfaces 210 communicate with each other via the peripheral bus 212. The peripheral bus 220 connects to a number of peripherals that support core functions of the wireless communication device 200, including timers, interrupts, radio/filters/system registers, counters, UART, GPIO interfaces, among others. The memory 208 may further store an operating system and applications. In some examples, the memory may store recorded information about captured frames and packets. The input/output interface unit 210 allows for exchange of information with a user of the wireless communication device. The antenna unit 206 can include a single antenna and/or can include multiple antennas. For example, multiple antennas can be used to implement Multiple Input Multiple Output (MIMO) techniques, among others.

FIG. 2B illustrates a schematic block diagram of a receiver data flow architecture 250 that can be used to receive Wi-Fi packets over the network. In one illustrative example, the receiver data flow architecture 250 illustrated in FIG. 2B can correspond to or otherwise be associated with the wireless communication device 200 illustrated in FIG. 2A. Radio signals are received over the WM and translated into electrical signals by the receiving antenna 252 (e.g., which can be the same as or similar to antenna 206). The received signal is conditioned using a series of analog filters 254 (e.g., depicted as analog RF receive (Rx) filters) before being converted into a digital signal equivalent using an Analog-to-Digital Converter (ADC) 256. The sampled signal output of ADC 256 is conditioned again using a filter bank 258, which can include one or more digital RF filters and/or a farrow, before the samples are collected in an asynchronous receiving First-In-First-Out (FIFO) data structure 260.

Samples in FIFO structure 260 can be accessed by a plurality of modules. For example, samples can be accessed by a packet detect module and a sub-band module, both of which may be included in the lower-level PHY portion 262 depicted in FIG. 2B. In some embodiments, the lower-level PHY portion 262 is itself included in the PHY processor 216 illustrated in FIG. 2A.

The packet detect module included in the lower-level PHY portion 262 includes hardware and/or implement algorithms that is used to analyze the initial sections of the PPDU in the time domain. Based on the analysis, the packet detect module is used to recognize a received frame and synchronize frequency and timing of the wireless communication device with the packet being received. The sub-band module included in the lower-level PHY portion 262 includes hardware and/or implement algorithms that can be used to detect which subchannel in the allocated frequency band is being used for the packet being received.

Once a packet is detected and the relevant subchannel is established, samples can be forwarded to an upper-level PHY portion 264. The upper-level PHY portion 264 can be included in the PHY processor 216 illustrated in FIG. 2A. In some aspects, upper-level PHY portion 264 is used to process and decode Orthogonal Division Multiplexing (OFDM) symbols (e.g., with the support of a coprocessor module) to reconstruct the full PPDU. The reconstructed PPDU is output by the upper-level PHY portion 264 and subsequently processed by the MAC layer processor 266. The MAC layer processor 266 is used to extract the data payload from the PPDU and provide the relevant information to the HOST layer 268 for consumption.

In some examples, the MAC layer processor 266 illustrated in FIG. 2B can be the same as or similar to the MAC processor 214 illustrated in FIG. 2A. In some cases, the HOST layer 268 illustrated in FIG. 2B can include or otherwise can be the same as or similar to the HOST processor 218 illustrated in FIG. 2A.

FIG. 2C is a schematic block diagram of a transmitter data flow architecture 280 that can be used to transmit RF signals over a wireless medium, in accordance with some examples. More particularly, FIG. 2C illustrates a simplified schematic block diagram of a transmitter data flow architecture 280 used for transmitting radio signals over a WM. Data can be generated from a HOST or APP module 282 and packaged in a MAC level Protocol Data Unit (MPDU) to be routed over the wireless network by the MAC management module 284. The PHY module 286 interfaces with the WM and compiles a PPDU by adding a PHY preamble and the tail to the MPDU. Usually a Modulation Coding Scheme (MCS) for transmission of the packet over the medium is established using a rate control algorithm by the MAC module 284 or the PHY module 286. The modulation scheme selected can define the modulation technique to be used to transmit the data on the WM and the coding rate. Based on the modulation scheme selected, for example Quadrature Amplitude Modulation (QAM) 64, the PPDU is modulated to be transmitted on the WM. The encoder module 288 generates signals corresponding to points of QAM constellation symbols (groups of bits of the PPDU) which can be encoded using polar (r-θ) or cartesian (Q-I) coordinates. The modulation is done by linking the encoder module 288 to a Digital Phase Lock Loop (DPLL) 290. The modulated signals may be filtered by analog filters 292 and transmitted using a transmitting antenna 294.

As noted previously, aspects of the present invention are directed to systems and methods for interference handling in a wireless device (e.g., wireless receiver). In some embodiments, a desensitization (e.g., referred to interchangeably as “desense”) mechanism is provided that can be used to dynamically adjust the gain of a receiver in response to detected interference signals, to thereby improve packet reception reliability of the receiver. In particular, the gain of the receiver can be reduced by a two stage reduction process where the receiver initially listens on the wireless medium using a first gain that is a maximum gain of the receiver, detects an interference while using the maximum gain and triggers a reduction to a second gain configured by an AGC mechanism, before later detecting a packet while using the second gain, which triggers a further reduction from the second gain to a third gain that is used to complete the packet reception.

The first gain is higher than both the second gain and the third gain, and as noted above, may be the maximum gain of the receiver. The second gain can be based on an initial gain reduction implemented to reduce the receiver gain from the maximum value. For example, the reduction from the first, maximum gain to the second gain can be performed according to an AGC trigger in response to the interference detection, where a value of the second gain is less than the maximum gain and may be determined by the AGC based on a power level of the interference detection. After reducing from the maximum gain to the second gain in response to the interference detection, the receiver may be configured to hold the second, reduced gain to continue listening until the next packet is received (or a configured timeout duration is reached). The detection of a packet while holding the second gain for the receiver (i.e., detection of a packet before reaching the configured timeout duration) can be used to trigger a further reduction of the receiver gain, from the second gain to the third gain, where the third gain is less than the maximum gain and less than the second gain. The third gain is then used by the receiver to complete the packet reception.

In some examples, the first gain is a maximum gain of the receiver, the second gain is a reduced gain associated with the detected interference, and the third gain is backoff gain equal to the second gain minus an offset value (e.g., also referred to as a backoff value) and used for the packet detection and/or reception. In some embodiments, the third gain (e.g., the backoff gain) is the gain that is configured for the receiver and used to perform packet detection and/or reception according to aspects of the present invention. The third gain may be referred to as a backoff gain based on examples where the third gain is determined based on applying a reduction to cause the receiver to backoff from the second gain. The reduction from the second gain may be a fixed offset (e.g., 6 dB, or various other offset values larger or smaller than 6 dB) and/or may be a dynamically determined or adjusted offset amount, according to various embodiments.

In some aspects, the systems and methods described herein can be used to provide automatic gain control (AGC) techniques for a wireless device such as a wireless receiver, where the AGC techniques are implemented based on using a receiver desensitization (e.g., desense) technique configured to dynamically adjust the receiver gain, for example as noted above. Embodiments of the invention can correspond to an AGC method that includes setting a first receiver gain for a wireless device (e.g., wireless receiver) to listen on a wireless medium, listening with the first receiver gain for any signal on the wireless medium with a power level that exceeds a configured AGC trigger threshold (also referred to herein as a configured AGC threshold), and in response to detecting a power level that exceeds the configured AGC trigger threshold, determining a presence or absence of a valid packet at the wireless device within a configured (e.g., pre-defined, etc.) time window.

In some embodiments, the wireless receiver is configured to identify (e.g., determine) that an interference signal is present on the wireless medium when no valid packet is detected within the configured time window for the AGC desense timeout (also referred to as a desense timeout or desense timeout duration). Identification of an interference signal based on determining no valid packet has been detected within the AGC desense timeout window can cause the wireless device (e.g., wireless receiver) to automatically adjust the receiver gain to an adjusted gain value that desensitizes (e.g., desenses) the receiver for subsequent monitoring of the wireless medium after the identification of the interference signal, as will be described below with reference to the figures. For example, the receiver gain can be automatically adjusted from a maximum gain value to a first gain value using an AGC algorithm, then reduced to a second gain value corresponding to the identification or detection of the interference signal, where the second gain is less than the first gain to thereby desense the receiver. The second gain is then used by the receiver for the subsequent monitoring of the wireless medium after the identification of the interference signal, until either a packet arrival or a configured duration of a monitoring period expires. In some embodiments, the configured duration can be set equal to, or otherwise based on, a maximum Transmission Opportunity (TxOp) duration indicated in a WiFi packet header field. In various embodiments, a receiver in a wireless communication device may implement a desense mechanism to mitigate the effects of high-power interference that can impair packet reception. The receiver may use an AGC unit to adjust the gain of one or more amplifiers, such as a Low Noise Amplifier (LNA), a variable gain amplifier, an intermediate frequency amplifier, or a baseband amplifier, etc., among various others, to maintain a suitable output signal level. The desense mechanism can be initiated (e.g., triggered, etc.) when the receiver detects energy on a wireless medium that exceeds one or more configured AGC trigger thresholds. Following the AGC trigger event, the receiver can be configured to attempt detection of a valid packet, for example by searching for a Short Training Field (STF) of a packet preamble within a configured duration of the monitoring period, etc. Detection of a valid packet arrival can cause the receiver to perform a further gain reduction from a second gain triggered in response to interference detection, to a still lower third gain used to receive the packet.

In some embodiments, the disclosed systems and methods for receiver dynamic desensitization based on detected interference power level information can be implemented by, or for, one or more Wi-Fi HaLow devices. Such devices may operate in accordance with the IEEE 802.11ah standard over Sub-1 GHz (S1G) license-exempt bands, thereby enabling extended-range and lower-power Wi-Fi connectivity for various applications. Wi-Fi HaLow devices operate in the license-free ISM (Industrial, Scientific, and Medical) frequency bands under one gigahertz (GHz). A Wi-Fi HaLow AP can provide connectivity to thousands of Stations STAs within a network coverage of approximately a one-kilometer radius. Wi-Fi HaLow supports various bandwidths, including 1 MHz, 2 MHz, 4 MHz, 8 MHz, and 16 MHz, which are approximately one order of magnitude narrower (e.g., 10 times narrower) than the bandwidths utilized by the IEEE 802.11ac (Wi-Fi 5) standard.

High-power interference can cause significant impairments to packet reception in wireless communication systems such as Wi-Fi HaLow. For example, Wi-Fi HaLow devices may be more susceptible to negative effects of relatively high-power interference due to the sub-1 GHz (S1G) operational frequency bands. In many cases, the S1G bands are slightly regulated or license-free bands, and are increasingly congested with higher-powered services and devices, many of which legally transmit at power levels that can significantly exceed those of lower-powered HaLow devices. The low-power design and extended range used for many HaLow devices and receivers can correspond to relatively high receiver sensitivities designed to detect weak signals from distant HaLow or IoT devices. These high receiver sensitivities, while beneficial for long-range communication, make HaLow devices more vulnerable to packet reception degradation in the presence of higher-power interference signals.

In some aspects, a receiver is configured to detect the presence of interference (e.g., interference signals, etc.) by checking for a reception of a valid Wi-Fi packet following each automatic gain control (AGC) trigger event determined or generated by the receiver. For example, in IEEE 802.11 systems such as Wi-Fi HaLow, among various others, a valid packet reception can be identified or determined by a receiver based on the receiver detecting the Short Training Field (STF) or other portion of a packet preamble included within or otherwise indicative of the valid packet reception. For example, the STF is the initial part of the packet preamble, and can be used by receivers to perform synchronization and AGC convergence, etc. If no packet is detected within a configured duration of the monitoring period (e.g., no packet reception occurs or is detected within the monitoring period at the receiver, etc.), any observed energy detected at the receiver without the packet detection is classified as interference rather than a legitimate packet transmission.

Once interference is identified, the system may estimate a corresponding interference power level for the observed energy that was classified as interference, and subsequently can adjust the receiver gain according to the estimated interference power level, to thereby minimize an impact of the detected and classified interference signal. For example, as noted above, the estimate of the corresponding interference power level can be used to adjust the receiver gain from a first gain to a reduced gain based on the interference power level estimate (e.g., to a second gain). After implementing the downward reduction in receiver gain according to the estimated interference power level, the receiver may be configured to continue monitoring the channel at the reduced gain level (e.g., the reduced gain level due to the downward adjustment from the first gain to the second gain according to the estimated interference power level) for a configured duration of the monitoring period, for example, up to 15 milliseconds (ms), which aligns with the maximum Transmission Opportunity (TXOP) duration commonly used in 802.11ah communication systems.

An AGC desense timeout (e.g., timer, time duration, time window, etc.) can be triggered upon the expiration of the configured duration of the monitoring period for the gain reduction corresponding to the interference power level estimate. In some embodiments, the AGC desense timeout is a configured value corresponding to and/or associated with the disclosed desense mechanism. In some embodiments, the desense mechanism is configured to use the AGC desense timeout to prevent one or more interference signals on the wireless medium from continuously or repeatedly triggering and re-triggering the performance of AGC at the wireless receiver unnecessarily. In one illustrative example, the desense mechanism prevents, mitigates, and/or reduces the repeated triggering and re-triggering of AGC by setting the front-end gain of the wireless receiver to a reduced value that is lower (e.g., less) than the level originally selected by an AGC algorithm by a configured offset amount. For example, the desense mechanism can correspond to setting the front-end gain of the wireless receiver to a reduced second gain that is less than the first gain that was previously selected by the AGC algorithm in response to the interference detection or determination. For example, in some embodiments, the front-end gain may be set to a reduced gain value (e.g., the second gain) that is lower than the level originally selected by the AGC algorithm identifying an interference signal by an offset of 6 decibels (dB), etc. It is noted that the example of the 6 dB backoff or reduction from the first gain to the second gain is provided for purposes of illustration and example, and is not intended to be construed as limiting. As contemplated herein, various embodiments of the invention may additionally, or alternatively, use a fixed gain backoff or reduction amount that is larger or smaller than the example of 6 dB, and may in at least some embodiments use a dynamically or adaptively determined gain backoff or reduction amount that is determined according to measured or signaled parameters and characteristics for one or more signals associated with the receiver, etc.

In some embodiments, the desense mechanism is configured to maintain, for the wireless receiver, the interference power level(s) to be below the configured AGC trigger threshold value. For example, the reduced gain setting (e.g., the second gain) may be maintained either until a valid packet is detected or until the AGC desense timeout duration expires, thereby balancing sensitivity and robustness in the presence of spurious or short-duration high-power interference. Without the desense mechanism described herein, a wireless receiver may struggle to handle strong interference effectively, causing reduced packet detection reliability and incorrect system gain configuration, among other potential performance degradations for the wireless receiver, etc.

In a receiver of a wireless device, an AGC component, mechanism, algorithm, etc., can adjust the gain of one or more amplifiers included in and/or associated with the receiver and/or the wireless device, to thereby maintain a consistent output level (e.g., a target output or target level, etc.) that is decoupled from variations that may be present, or that may occur, in the input signal strength measured by the receiver. For example, AGC can control a respective gain corresponding to a Low Noise Amplifier (LNA) included in a front-end portion of the receiving chain of the receiver, etc. The LNA is configured to boost (e.g., amplify) weak signals prior to filter and/or down-conversion applied by subsequent, downstream components included in the same signal processing chain as the LNA. The boost or amplification by the LNA prior to filtering or down-conversion can be used to improve sensitivity and maintain a relatively low noise and/or signal-to-noise-ratio (SNR), etc., for the receiver and its receive processing chain, etc.

In some examples, the receiving chain of a wireless device or receiver may include one or more additional amplifiers in addition to the LNAs, where the additional amplifiers are also controlled by AGC. For example, the additional amplifiers that can be included in the receiving chain and controlled by AGC may include one or more variable gain amplifiers, one or more intermediate frequency amplifiers, and/or one or more baseband amplifiers, etc., among various others. In an illustrative example, the systems and techniques herein can be used to implement an improved AGC desense mechanism for desensitizing (e.g., reducing) a receiver gain according to a measured interference signal corresponding to one or more interference sources and/or interference signals during packet reception by the receiver.

In an illustrative example, the AGC desense mechanism with interference handling can implement an initial gain setting phase using an initial gain of the receiver, a listening phase with an adaptive gain, an AGC desense timeout phase, and a packet detection phase using a refined (e.g., appropriate, etc.) gain setting determined based on the valid packet. The four example phases of the illustrative example of the AGC desense mechanism with interference handling are described in turn below.

A first phase of the AGC desense mechanism with interference handling can correspond to and/or may comprise an initial gain setting phase for the AGC desense mechanism. In the initial gain setting phase, the receiver device can be configured to determine and set an initial value for the receiver gain, also referred to as a first gain and/or a first receiver gain. In some embodiments, the initial value for the receiver gain is equal to and/or otherwise corresponds to or is based on a maximum gain associated with the receiver. In some examples, the maximum gain can be the largest (e.g., highest) gain supported by the receiver, and/or the largest gain that can be configured without saturating/over-saturating the receiver, etc. In some embodiments, the initial value for the receiver gain may be determined based on an AGC algorithm that runs or executes before packet reception at or by the receiver device. In another example, the initial value for the receiver gain is first set to a maximum gain then reduced to a gain that is determined based on the AGC algorithm.

A second phase of the AGC desense mechanism with interference handling can comprise a listening phase, where the receiver is configured to monitor the wireless medium using the first gain and is adaptively configured to adjust the receiver gain(s) from the first gain to a lower, second gain in response to detecting an interference signal with a power level exceeding the AGC trigger threshold. Upon detection of interference by the receiver device, prior to detection of a valid packet, the receiver is configured to determine an estimated interference power level corresponding to the detected interference. In some embodiments, the estimated interference power level determined by the receiver device may be derived based on the receiver device identifying an interference signal and subsequently detecting (e.g., estimating and/or determining, etc.) the power level of the identified interference signal.

For instance, an interference signal may be identified by the receiver device based on the receiver device detecting a power level on the wireless medium that is greater than (e.g., exceeds) a configured AGC trigger threshold value. In some embodiments, identifying an interference signal may be based on the receiver device detecting a power level exceeding the AGC trigger threshold value, while also determining that no valid packet reception has been detected within a predefined (e.g., configured) period. For example, identifying an interference signal may be based on the receiver determining that both a first condition, corresponding to the detected power level exceeding the AGC trigger threshold, and a second condition, corresponding to the receiver failing to detect a valid packet within the predefined period, are currently satisfied or met. In response to both conditions being met for the receiver device based on the comparisons to the AGC trigger threshold and the packet reception time window duration/timer, the receiver is configured to classify the signal associated with the detected power level above the AGC trigger threshold as an interference signal. The receiver can subsequently use the AGC to automatically set one or more adjusted gain values (e.g., the second gain) for a corresponding one or more components in the receiving chain, where the adjusted/second gain values are reduced relative to the first gain according to the detected power level. In some embodiments, the receiver can perform gain setting based on the detected interference power level to reduce the receiver gain from the first gain by a configured or predefined fixed amount (e.g., a configured offset amount, etc.) and/or can be configured to reduce the receiver gain by a variable amount that varies, at least in part, based on the value of the detected interference power level, etc. In some embodiments, the reduction from the first gain to the second gain in response to the interference detection may be implemented based solely on the detected interference power level. If there's no significant interference signals detected (e.g. no signal with a power level exceeding the AGC trigger threshold), the receiver can monitor the wireless medium using the first gain.

In some cases, the receiver uses the second, listening phase to adjust the receiver gain from the first gain to the reduced, second gain according to the detected interference signals with energy above the AGC trigger threshold, in order to prevent the AGC from frequently reacting to high-power interference that would otherwise activate an AGC that does not implement the presently disclosed improved AGC mechanism(s). For instance, the receiver can be desensitized (e.g., desensed) to reduce one or more receiver gain values within the receiving chain, where the receiver is considered desensed when the adjusted gain is reduced. The reduced gain adjustment corresponding to implementing or configuring the second gain in response to the interference detection can be maintained (e.g., held) by the receiver and its receiving chain for a configured (e.g., pre-determined, etc.) time duration, which may be used by the receiver to detect one or more incoming packets that may be received while the receiver remains in the desense state with the adjusted (reduced) second receiver gain(s) corresponding to the detected power level of the classified interference signal.

In the listening phase, and as noted previously, the disclosed desense mechanism can be used to adjust the receiver gain to prevent the receiver from being overwhelmed by relatively high-power interference signals that may otherwise dominate the detections or receptions by the receiver in the absence of the disclosed desense mechanism. The mitigation and reduction of the impact upon the receiver of the relatively high-power interference signals can be seen to provide and/or ensure increased reliability of packet detection by the receiver. In some embodiments, a front-end gain of the receiver may be set to an adjusted receiver gain that is lowered or reduced by a configured offset amount of 6 dB, etc., with offset and/or reduction values both larger and/or smaller than 6 dB also contemplated within the scope of the present disclosure. In the example of a configured 6 dB offset to reduce the front-end gain of the receiver, the front-end gain can be reduced to 6 dB lower than the level selected by the AGC algorithm to desense the receiver to reduce the interference power level to be below (or likely to fall below) the AGC trigger threshold.

In the third phase, the AGC desense mechanism with interference handling can implement an AGC desense timeout mechanism. In some cases, the AGC desense mechanism implements an AGC desense timeout to prevent the receiver from waiting indefinitely for a next packet detection or reception. For example, the AGC desense mechanism can use the AGC desense timeout as a maximum time duration or length of time for which the receiver will monitor or wait for the next packet detection or reception while maintaining (e.g., holding) the reduced receiver gain set to the second gain corresponding to the interference detection, as described previously above.

The fourth phase of the AGC desense mechanism may be triggered by the expiration of the configured duration of the monitoring period or timer duration of the third phase, to cause the receiver device to reset the receiver gain back to the first gain for the receiver, for example in response to determining that no packet has been detected within the configured duration of the monitoring period. As noted previously, in some embodiments the length or duration of the monitoring period can be based on, or equal to, a maximum Transmission Opportunity (TXOP) specified in the applicable wireless communication standard used by the receiver device, etc. The AGC desense timeout mechanism can be used to prevent the receiver from remaining in the desense state for an extended period. Unlike conventional AGC implementations that react to each energy detection event individually, the described desense mechanism introduces a timed gain suppression strategy to perform an initial reduction from a first (e.g., maximum) gain of the receiver to a second gain that is reduced from the first gain by an amount corresponding to the power level of an interference detection, followed by holding the reduced, second gain for a configured timeout duration corresponding to a window of packet detection opportunity. If a packet arrives within the window of packet detection opportunity provided by the configured desense timeout duration, the gain of the receiver is further reduced to third gain that is set in response to the valid packet. The amount of the gain reduction from the second gain to the third gain may be a fixed offset amount or value, and/or may be a dynamically determined or adjusted offset amount or value, as noted previously. Advantageously, by holding the reduced gain level of the second gain for a fixed duration (e.g., 15 ms or other duration of the configured AGC timeout, etc.), the systems and techniques described herein can be seen to prevent and/or avoid spurious AGC reactions to transient or persistent interference on the wireless medium, while furthermore maintaining readiness to detect and receive legitimate packets at the wireless receiver by implementing the third gain that is lower than the second gain, in response to the packet arrival. The disclosed timing-based approach for AGC with receiver desensitization according to measurements of a detected interference signal can be used to enable improved robustness of receivers and/or receiver devices in the presence of interference on a wireless medium. It is further noted that while the example embodiments herein may be described and/or illustrated with reference to wireless communication devices and/or receivers implemented using 802.11ah (Wi-Fi HaLow), such examples and embodiments are provided for purposes of clarity of explanation and illustration, and it is expressly contemplated herein that aspects of the present disclosure and/or improved desense mechanism herein may be equally applicable, in whole and/or in part, to any packet-based wireless communication, etc. that is configured to use or support AGC during preamble detection in packet reception.

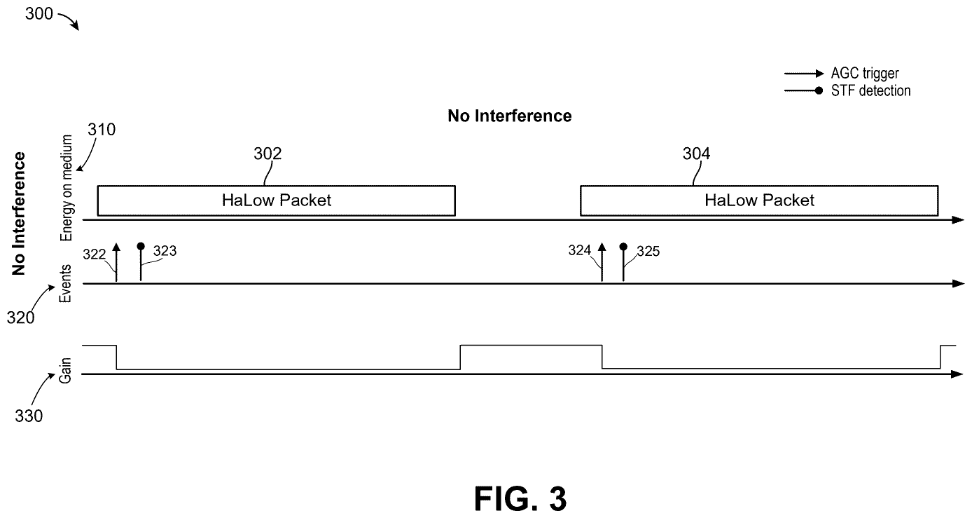

FIG. 3 is a timing diagram 300 illustrating an example of automatic gain control (AGC) operations for a receiver, where the example AGC operations can be performed in the absence of relatively strong interference to control amplifier gain of the receiver to detect one or more incoming packets, in accordance with some examples. In the example timing diagram 300, a first timeline 310 is illustrated with time on the horizontal axis (e.g., x-axis) and a representation of detected energy on the wireless medium on the vertical axis (e.g., y-axis). For example, the energy on medium timeline 310 depicts a first packet 302 (e.g., a first Wi-Fi HaLow packet, etc.) corresponding to a first time and a second packet 304 (e.g., a second Wi-Fi HaLow packet, etc.) corresponding to a second time that is later than the first time. A second timeline 320 is illustrated, corresponding to detected events corresponding to the energy on medium timeline 310. For example, the beginning of the first HaLow packet 302 on the first timeline 310 corresponds to a first AGC trigger 322, which may be determined by an AGC or AGC mechanism of the receiver, etc. The first AGC trigger can occur at a time that is equal to or later than the start time of the reception of the first HaLow packet 302. Following the first AGC trigger 322, the event timeline 320 includes a first STF detection event 323, corresponding to detection of the STF portion of a packet preamble portion of the first HaLow packet 302, as described previously above. A third timeline 330 illustrates the amplifier gain of the receiver associated with and/or implementing the AGC algorithm, with gain shown on the vertical axis (e.g., y-axis). The three timelines 310, 320, and 330 may each use the same time scale for their respective horizontal axes (e.g., respective x-axes). The gain timeline 330 illustrates that the amplifier gain of the receiver is reduced from a higher value (e.g., a maximum gain or a gain set by an AGC algorithm), to an adjusted, lower value corresponding to the first AGC trigger 322. For instance, the time of the first AGC trigger 322 can be the same as or similar to the time at which the gain timeline 330 illustrates the reduction in the amplifier gain of the receiver from the higher value, to the lower adjusted value for packet detection. The lower adjusted amplifier gain value can be maintained on the gain timeline 330 until the end of the first HaLow packet 302 reception, at which point the amplifier gain is increased back to (e.g., returned to) the original, higher amplifier gain value. A same or similar process is repeated for the second HaLow packet 304, with the amplifier gain reduced on the gain timeline 330 from the higher gain to the lower gain value in response to a second AGC trigger 324 at a time the same as or later than the start time of the reception of the second HaLow packet 304. The second AGC trigger 324 can be followed by a second STF detection event 325, based on detection of the STF portion of a packet preamble portion of the second HaLow packet 302.

In some embodiments, the first packet 302 and the second packet 304 are packets that are compliant with the IEEE 802.11ah (Wi-Fi HaLow) standard. As noted above, the amplifier gain for the receiver (e.g., shown on the third timeline 330) is initially set high by the AGC algorithm or a predetermined maximum value for the receiver to continuously monitor the wireless medium for incoming packets. When the receiver detects a signal (e.g., energy on the medium, represented on the first timeline 310) with a power level exceeding a configured AGC trigger threshold, the receiver is prompted or caused to initiate an AGC trigger event to adjust the gain from the higher gain to the reduced gain. For example, detection corresponding to the start of the first HaLow packet 302 exceeding the configured AGC trigger threshold can prompt or cause the receiver to initiate the first AGC trigger event 322; detection corresponding to the start of the second HaLow packet 304 exceeding the configured AGC threshold prompts or causes the receiver to initiate the second AGC trigger event 3243, etc.. The receiver gain (e.g., receiver amplifier gain) is reduced from the higher gain to the lower gain according to the AGC trigger event (e.g., AGC trigger events 322, 324, etc.) for packet reception, as shown in the third timeline 330. In the example of the timing diagram 300 of FIG. 3, the signal power level for the energy detected on the medium in first timeline 310 exceeding the AGC trigger threshold corresponds to a valid HaLow packet (e.g., either first HaLow packet 302 or second HaLow packet 304, as the timing diagram 300 is illustrated under an assumption of no significant interference on the wireless medium, as noted above), the receiver successfully detects a valid packet preamble, such as a STF (e.g., with the detection causing the first STF detection event 323 and/or the second STF detection event 325, respectively). The STF detection events 323, 325 are triggered at respective times following the AGC trigger event time that precedes the STF detection event and correspond to the same HaLow packet 302 or 304, indicating and/or confirming that the detected energy corresponds to the start of the respective HaLow packet 302, 304.

After reception of the HaLow packet is completed (e.g., once the first or second HaLow packet 302, 304 has been completely received by the receiver), the AGC gain, as shown on the third timeline 330, is reset back to the initial, high gain value for the listening phase of the AGC, as described previously above. The same gain setting activity comprising reduction of gain in response to an AGC trigger event 322, 324, and reset to the initial, high gain value following the end or completion of packet reception for the packet that caused the AGC trigger event 322, 324 may be repeated for receiving each of the following packets, such as the second HaLow packet 304 and beyond, etc. For example, the second AGC trigger event 324 is another AGC trigger event that indicates the moment (e.g., particular time on the timelines 310, 320, 330 of FIG. 3, etc.) when the receiver detects that the signal power level on the wireless medium (e.g., corresponding to first timeline 310) exceeds the configured AGC trigger threshold. The amplifier gain on the third timeline 330 is then reduced by the AGC trigger event for packet reception, and another STF detection event 325 represents and/or indicates a STF of the second HaLow packet 304 is successfully detected by the receiver. Similarly, the receiver resets the gain after completely receiving the second HaLow packet 304, etc.

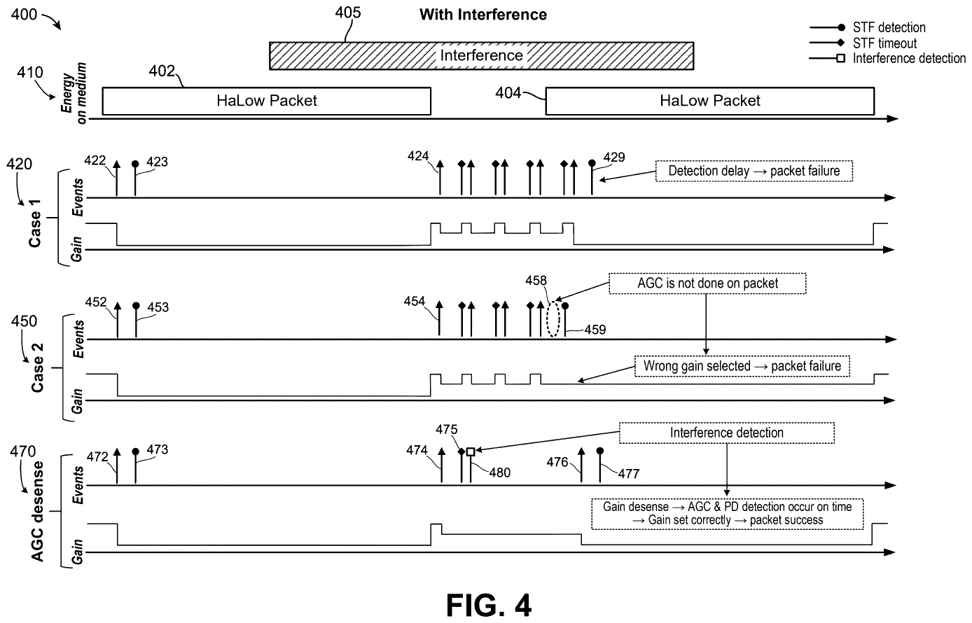

FIG. 4 is a timing diagram 400 illustrating first and second examples (of performance degradation that may be associated with AGC operations of a wireless receiver in the presence of one or more relatively high-power interference signals 405 on the wireless medium, and further illustrating a first example of automatic and dynamic receiver desensitization for improved AGC handling of interference during packet reception, in accordance with some examples. A first, energy on medium timeline 410 of FIG. 4 can correspond to the first, energy on medium timeline 310 of FIG. 3, with the energy on medium timeline 410 of FIG. 4 including a first HaLow packet 402 the same as or similar to the first HaLow packet 302 of FIG. 3, and a second HaLow packet 404 the same as or similar to the second HaLow packet 304 of FIG. 3. The energy on medium timeline 410 further includes one or more interference signals 405, which can be relatively high-power interference signals on the wireless medium, as noted above.

The timing diagram 400 illustrates a first case 420 of performance degradation of conventional AGC without the disclosed AGC receiver desense mechanism, and a second case 450 of performance degradation of conventional AGC without the disclosed AGC receiver desense mechanism. A third case 470 illustrates the respective event and gain timelines for a first example of the presently disclosed AGC receiver desense mechanism operating to improve the performance and packet detection accuracy of the receiver even in the presence of the relatively strong or high-power interference 405 on the wireless medium.

For example, the first case 420 and the second case 450 illustrate two scenarios of performance degradation of AGC in the absence of the disclosed desense mechanism, two example scenarios are illustrated that may cause critical performance issues in a wireless receiver when the desense mechanism is not employed. In particular, the first case 420 of example performance degradation can correspond to the detection of a first AGC trigger event 422 indicating the detection of a high signal power level on the wireless medium (e.g., corresponding to the correct detection of the start of the first HaLow packet 402 shown in timeline 410), followed by a first STF detection event 423 and a reduction in the amplifier gain of the receiver for packet reception, as shown on the gain timeline of the first case 420. For example, upon successful detection of a STF in a preamble portion of the first HaLow packet 402, the first STF detection event 423 is generated to indicate that the high signal power level on the energy-on-medium timeline 410 corresponds to a valid HaLow packet 402. In the first case 420, the first AGC trigger 422 and first STF detection event 423 are associated with the receiver setting the amplifier gain to reduce from the first gain to the adjusted, lower value for reception of (e.g., for receiving) the first HaLow packet 402, as described previously.

The relatively high-power interference signal 405 is present on the wireless medium corresponding to the first timeline 410 beginning from midway through the reception of the first HaLow packet 402, and persisting through the end of the reception of the first HaLow packet 402, through the beginning of reception of the second HaLow packet 404, and ultimately ending after the arrival/beginning of reception of the second HaLow packet 404 (e.g., midway through the reception of the second HaLow packet 404, etc.). In the example of the first performance degradation case 420, even when the receiver initially sets the gain correctly at the end of reception of the first HaLow packet 402 (e.g., by increasing or resetting the receiver amplifier gain back to the initial, higher gain value comprising the first receiver gain), the presence of the ongoing interference signal 405 triggers repeated AGC trigger events beginning from the spurious/erroneous AGC trigger event 424, with each one of the repeated AGC trigger events due to the interference 405 followed by a corresponding spurious/erroneous STF timeout event.

The spurious/erroneous STF timeout event is represented by a line terminating in a shaded diamond marker, and is different from the STF detection event terminating in a shaded circle marker (e.g., such as the STF detection event 423, etc.). The STF detection events terminating in shaded circles represent successful detection of an STF within a fixed period after an AGC trigger event, where a packet preamble is expected if the AGC trigger event marks or corresponds to the beginning of a valid packet reception on the wireless medium. Conversely, the spurious/erroneous STF timeout events represented by the lines with shaded diamond markers represent a failure to detect an STF within the fixed period where the packet preamble of a valid packet reception would be expected following the beginning of a valid packet reception corresponding to an AGC trigger event. In other words, the diamond marker STF timeout events are events generated in the example of the first performance degradation case when no STF is detected by the receiver within a fixed period after an AGC trigger event. The STF timeout event can be used as an indication that the detected energy causing an AGC trigger event (e.g., such as the AGC trigger event 424, etc.) does not correspond to a valid packet reception, and may instead be energy that is detected due to and/or corresponding to spurious noise or interference (e.g., such as the relatively high-power interference 405, etc.). This persistent adjustment of increasing and decreasing the amplifier gain starting from the AGC trigger event 424, at the first time following the end of the first HaLow packet 402 that overlaps with the interference signal(s) 405, causes a repeating cycles of AGC trigger events 424, . . . , etc., with each AGC trigger event between valid HaLow packets 402, 404, . . . , etc., separated from an STF timeout event by the fixed period of time configured as the STF timeout duration. The cycle of repeating AGC trigger events spuriously caused by the interference signal 405 on the wireless medium can cause a detection delay in the receiver determining the reception of the second, valid HaLow packet 404, which is not detected until the first AGC event (following an STF timeout event) is triggered within the time period of the reception of the valid second HaLow packet 404.

In the example of the second case 450 of performance degradation in the absence of the disclosed desense mechanism, after the first HaLow packet 402 is successfully received (and the amplifier gain of the receiver is adjusted from the first to the lower gain in response to a first AGC trigger event 452 generated for the start of the reception of the first HaLow packet 402, followed by a corresponding STF detection event 453, as described above), the receiver again experiences a cycle of continuous and repeated responses of generating additional AGC detection events 454 for the high-power interference signal 405, with each additional AGC detection event 454 followed by a corresponding STF timeout event due to no valid packet being present on the wireless medium of the first timeline 410 (e.g., no STF detection success can be determined by the receiver for the period between the first HaLow packet 402 and the second HaLow packet 404, as the wireless medium of the first timeline 410 has only the interference signal 405 present). In the example of the second case 450 of performance degradation, the receiver amplifier gain is reduced to the adjusted, lower amplifier gain value (e.g., the second gain) following each one of the additional AGC detection events 454 during the period where only the interference signal 405 is present between the end of the first HaLow packet 402 and the beginning of the second HaLow packet 404. Some examples of the adjusted amplifier gain value (e.g. the second gain) are set according to the power level of the interference signal 405.

For example, the receiver amplifier gain in the second case 450 is reduced by each additional AGC trigger event 454 whenever there is a high power detection determined by the receiver due to the presence of the interference signal 405. After a corresponding STF timeout period subsequent to each additional AGC trigger event 454, in the second case 450, the receiver's amplifier gain is reset to the initial un-adjusted higher amplifier gain value (e.g., the first gain) for performing the listening phase described previously above. In each instance of amplifier gain adjustment corresponding to the additional AGC trigger events 454 between the first and second HaLow packets 402, 404, the receiver adjusts the amplifier gain in response to, and based on, the detected energy level of only the high-power interference signal 405, as no valid HaLow packet is present on the wireless medium during the period of time where the additional AGC trigger events 454 are generated. Because the receiver adjusts the amplifier gain based on the energy level of the high-power interference signal 405 rather than a valid packet signal for receiving the second HaLow packet 404, the adjusted (e.g., lower) receiver amplifier gain selected and implemented by the AGC algorithm in response is not the optimal receiver amplifier gain for the actual HaLow packet 404 when reception begins for second HaLow packet 404, and AGC is not performed for the second HaLow packet 404 at the time instance 458 corresponding to the beginning of the reception of the valid second HaLow packet 404. Instead, the receiver amplifier gain is configured by the AGC based on the power level of the interference signal 405. This wrong gain value is selected and implemented for the receiver amplifier at the time instance 458 when the second HaLow packet 404 reception beings, and accordingly, causes a misconfiguration in gain selection (e.g., incorrect receiver gain settings) and, ultimately, packet reception failure for the second HaLow packet 404 in the second case 450 of performance degradation.

In some embodiments, to address these issues caused by interference-triggered AGC behavior as in the examples of the first case 420 and/or the second case 450, the AGC desense mechanism shown as the third case 470 of the timing diagram 400 of FIG. 4 is introduced. In some aspects, after receiving the first HaLow packet 402 (and generating the corresponding first AGC trigger event 472 followed by the first STF detection event 473, as described above), the receiver continuously monitors the wireless medium and distinguishes between legitimate packet transmissions and the high-power interference signal 405 by detecting the presence or absence of a valid STF following an AGC trigger event. For example, when a high-power energy is detected by the receiver, the first and second performance degradation cases 420 and 450, respectively, would generate an AGC trigger event. In the example AGC desense case 470, a further check is performed following detection of high-power energy above the configured AGC trigger threshold, where the receiver performs the further check to determine whether or not a successful STF detection (e.g., such as successful STF detection 473 following the first AGC trigger event 472) follows the detection of the high-power energy within a specified or configured time window and/or time duration. If a successful STF detection 473 does not follow the AGC trigger event 472 or detection of high-power energy above the configured AGC trigger threshold, in the AGC desense case 470 the high-energy detection event is not classified as a packet detection or AGC trigger, and an AGC trigger event is not generated. Instead, the systems and techniques cause the receiver and/or AGC to classify the high-energy detection event that was not followed by a successful STF detection within the configured amount of time as an interference detection event 480.

For example, the AGC trigger event 474 in the example AGC desense case 470 is generated in response to detecting high energy above the AGC trigger threshold based on the presence of the interference signal 405 after the end of reception of the valid first HaLow packet 402. Because only the interference signal 405 is present, the configured STF detection period after the first additional AGC trigger event 474 corresponding to interference 405 times out without a successful STF detection, and an STF timeout event 475 is generated instead. Based on detecting that an AGC trigger event 454 was generated followed by an unsuccessful STF detection (e.g., followed by the STF timeout event 475), the systems and techniques described herein are configured to generate the interference detection event 480, indicating the classification of the high-power energy associated with the additional AGC trigger event 454 as an interference signal instead of a valid packet detection.

In response to generating or determining an interference detection event (e.g., the interference detection event 480), the receiver can be configured to proactively reduce its front-end gain for the receiving chain from the first gain to a second, reduced gain corresponding to the interference detection, as shown in the amplifier gain timeline at the lower half of the AGC desense timeline case 470. For example, the interference detection event 480 can cause the amplifier gain to be reduced from the initial, higher gain value (e.g., first gain) to an intermediate reduced/adjusted gain value (e.g., the second gain based on the detected interference power level) that is larger than the full gain reduction associated with the AGC detection event 472 for the true, valid first HaLow packet 402 detection. In other words, the interference detection event 480 can cause the amplifier gain to be reduced to a lower, second gain relative to the initial, higher amplifier gain (e.g., the first gain).

After the reduction in amplifier gain from the first gain to the lower, second gain, the receiver may be configured to hold the intermediate gain reduction triggered by the interference detection event 480 (e.g., hold the lower/reduced, second gain configured according to the power level of the detected interference) for a configured or predetermined duration that may be referred to as a configured duration of the monitoring period and/or an AGC desense timeout, etc. In some aspects, the receiver holds the intermediate gain reduction (e.g., the second gain) triggered by the interference detection event 480 until expiration of the AGC desense timer (e.g., until AGC desense timeout occurs), or until a valid packet detection is sensed or determined (e.g., corresponding to detecting the beginning of the second, valid HaLow packet 404, etc.), whichever is earlier. The lower, intermediate amplifier gain (e.g., the second gain) setting implemented in response to the interference detection event 480 is referred to as desense, and the desense mechanism can be used by the receiver to prevent unnecessary AGC triggers caused by both transient and persistent interference sources (e.g., corresponding to the additional AGC triggers 424 in the first case 420 of performance degradation in the absence of the desense mechanism, and corresponding to the additional AGC triggers 454 in the second case 450 of performance degradation in the absence of the desense mechanism).

As a result, the receiver remains properly configured to process an actual incoming HaLow packet (e.g., second HaLow packet 404), allowing the AGC trigger event 476 and STF detection event 477 to be properly triggered or generated to occur at acceptable (e.g., correct) timing corresponding to the actual beginning/start of the second HaLow packet 404, to thereby allow the receiver to receive the second HaLow packet 404 successfully and in its entirety. The AGC desense mechanism for the AGC desense case 470 shown in FIG. 4 illustrates the ability of the disclosed systems and techniques to ensure that the receiver amplifier gain is set accurately according to the power level of a valid packet signal only, while interference signals can be identified and prevented from causing an erroneous modification to the receiver amplifier gain as if the interference signal were a valid packet reception, thereby enabling successful packet reception by the receiver even in the presence of the high-power interference signal 405.

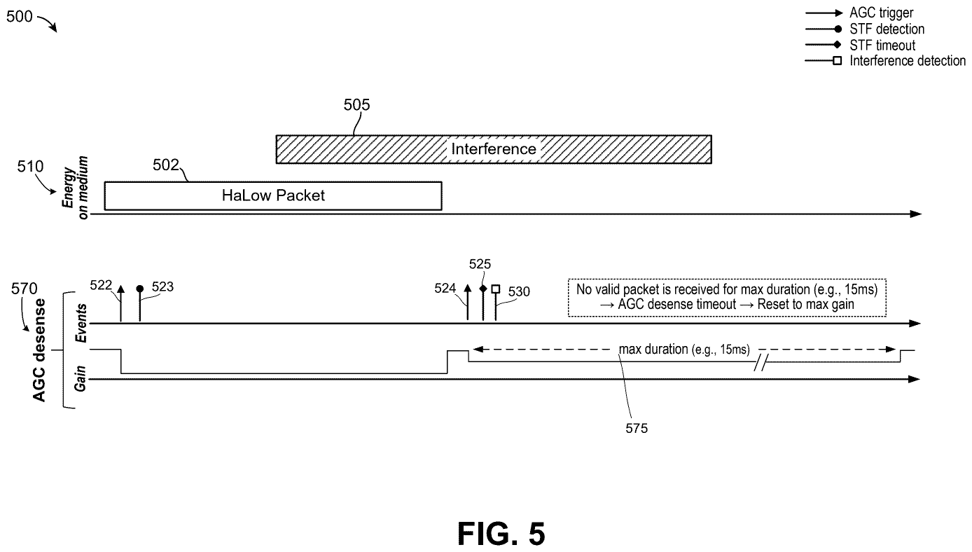

FIG. 5 is a timing diagram 500 illustrating another example of automatic and dynamic receiver desensitization for improved AGC handling of interference during packet reception, using an AGC desense timeout mechanism to reset the receiver gain from the second, reduced gain corresponding to the detected interference power level, back to the first gain of the receiver in response to a determination that the receiver has held the second, reduced gain for a time duration that is greater than or equal to a configured duration of the receiver desensitization, in accordance with some examples. The timing diagram 500 includes a first timeline 510 that can be the same as or similar to the first timeline 310 of FIG. 3 and/or the first timeline 410 of FIG. 4, with an interference signal 505 that can be the same as or similar to the interference signal 405 of FIG. 4. A first HaLow packet 502 can be received, and may be the same as or similar to the first HaLow packet 302 of FIG. 3 and/or the first HaLow packet 402 of FIG. 4. An additional example AGC desense timeline 570 can be similar to and/or can correspond to the example AGC desense timeline 470 of FIG. 4. For example, a first AGC trigger event 522 may be the same as or similar to the first AGC trigger event 472 of FIG. 4, and can correspond to the start of the first HaLow packet 502. A first STF detection event 523 can be the same as or similar to the first STF detection event 473 of FIG. 4, and can correspond to the detection of an STF within the packet preamble portion of the first HaLow packet 502, etc.

In some aspects, the example of the AGC desense timeline 570 of FIG. 5 illustrates an embodiment of the disclosed AGC desense timeout mechanism that can be configured to reset the receiver amplifier gain based on determining the expiration of a configured AGC timeout maximum duration 575, to thereby use the AGC desense timeout mechanism to prevent the receiver from being configured with the desense (e.g., desensitized) adjusted gain value (e.g., the second gain) for a long period of time (e.g., a period of time exceeding the configured duration 575, etc.). In this embodiment, after successfully receiving the first HaLow packet 502, an AGC trigger event 524 indicates there is a high-power signal in the wireless medium, due to the presence of the interference signal 505, and the gain is reduced accordingly. Since there is no STF detected within a predefined time window after the additional AGC trigger event 524, an STF timeout event 525 is asserted and an interference detection event 530 is generated following the STF timeout event 525 in a manner the same as or similar to the interference detection event 480 described above with respect to FIG. 4. The interference detection event 530 of FIG. 5 can be generated to confirm that the detected energy associated with the additional AGC trigger event 524 corresponds to a high-power interference signal (e.g., interference signal 505) and not a valid HaLow packet reception. The desense mechanism holds the reduced gain (e.g., the second gain) triggered by the interference detection event 530 for a configured duration 575, also referred to as the AGC desense timeout duration and/or the AGC desense timeout maximum duration, etc.

In some embodiments, the predetermined/configured duration of the AGC desense timeout duration 575 can be based on and/or equal to a maximum TXOP duration, for example, 15 milliseconds. If the receiver does not detect any valid packet during the predetermined duration for STF detection following the generation of the additional AGC trigger event 524, the receiver can be configured to determine and/or assume that the detected energy of the additional AGC detection event 524 does not correspond to a legitimate (e.g., valid) packet transmission. As a result, the AGC desense timeout 575 is triggered, and the receiver resets the gain back to a higher level for listening (e.g., the first gain of the receiver). This reset ensures that the receiver is re-primed to detect future valid packets with appropriate sensitivity, avoiding prolonged operation at reduced gain due to persistent or spurious interference. This AGC desense timeout mechanism balances interference mitigation with responsiveness to legitimate traffic, ensuring that the receiver does not remain in a desensitized state longer than necessary.

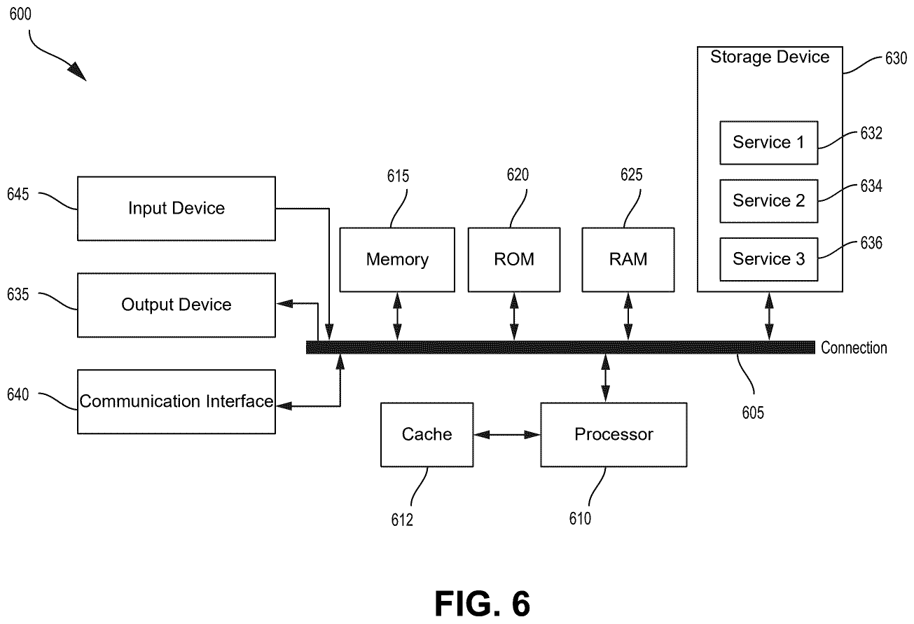

FIG. 6 illustrates a computing device architecture 600 of a computing device which can implement one or more techniques described herein. In some examples, the computing device can include a mobile device, a wearable device, an extended reality device (e.g., a Virtual Reality (VR) device, an Augmented Reality (AR) device, or a Mixed Reality (MR) device), a personal computer, a laptop computer, a video server, a vehicle (or computing device of a vehicle), or other device. The components of computing device architecture 600 are shown in electrical communication with each other using connection 605, such as a bus. The computing device architecture 600 includes a processing unit 610 and computing device connection 605 that couples various computing device components including computing device memory 615, such as Read Only Memory (ROM) 620 and Random-Access Memory (RAM) 625, to processor 610.

Computing device architecture 600 can include a cache of high-speed memory connected directly with, in close proximity to, or integrated as part of processor 610. Computing device architecture 600 can copy data from memory 615 and/or the storage device 630 to cache 612 for quick access by processor 610. In this way, the cache can provide a performance boost that avoids processor 610 delays while waiting for data. These and other engines can control or be configured to control processor 610 to perform various actions. Other computing device memory 615 may be available for use as well. Memory 615 can include multiple different types of memory with different performance characteristics. Processor 610 can include any general-purpose processor and a hardware or software service, such as service 1 632, service 2 634, and service 3 636 stored in storage device 630, configured to control processor 610 as well as a special-purpose processor where software instructions are incorporated into the processor design. Processor 610 may be a self-contained system, containing multiple cores or processors, a bus, memory controller, cache, etc. A multi-core processor may be symmetric or asymmetric.

To enable user interaction with the computing device architecture 600, input device 645 can represent any number of input mechanisms, such as a microphone for speech, a touch-sensitive screen for gesture or graphical input, keyboard, mouse, motion input, speech and so forth. Output device 635 can also be one or more of a number of output mechanisms known to those of skill in the art, such as a display, projector, television, speaker device, etc. In some instances, multimodal computing devices can enable a user to provide multiple types of input to communicate with computing device architecture 600. Communication interface 640 can generally govern and manage the user input and computing device output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, RAM, ROM, and hybrids thereof. Storage device 630 can include services 632, 634, 636 for controlling processor 610. Other hardware or software modules or engines are contemplated. Storage device 630 can be connected to the computing device connection 605. In one aspect, a hardware module that performs a particular function can include the software or processor readable codes stored in a computer-readable medium in connection with the necessary hardware components, such as processor 610, connection 605, output device 635, and so forth, to carry out the function.

The term “device” is not limited to one or a specific number of physical objects (such as one smartphone, one controller, one processing system and so on). As used herein, a device may be any electronic device with one or more parts that may implement at least some portions of this disclosure.

Individual aspects may be described above as a process or method which is depicted as a flowchart or a data flow diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, or a subprogram. When a process corresponds to a function, its termination can correspond to a return of the function to the calling function or the main function.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above.

The program code may be executed by a processor, which may include one or more processors, such as one or more Digital Signal Processors (DSPs), general purpose microprocessors, an Application Specific Integrated Circuits (ASICs), Field Programmable Gate Arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices.

What is claimed is:

1. A method for Automatic Gain Control (AGC) in a wireless device, the method comprising:
configuring a first gain for a receiver of the wireless device to listen on a wireless medium;
identifying a signal received on the wireless medium as an interference signal, wherein the signal is received using the first gain, and wherein the identification is based on a power level of the signal exceeding a configured AGC threshold without the signal including an indication of valid packet reception;
configuring, in response to the identification, a second gain for the receiver that is less than the first gain to thereby desense the receiver;
detecting an indication of packet arrival using the second gain, wherein the indication of packet arrival is detected within a configured duration of a monitoring period corresponding to the receiver using the second gain;
in response to the indication of packet arrival, adjusting gain information of the receiver to obtain a third gain less than the second gain; and
receiving, using the receiver configured with the third gain, a packet corresponding to the indication of packet arrival.

2. The method of claim 1, further comprising starting listening on the wireless medium with a maximum gain for the receiver before configuring the receiver to the first gain.

3. The method of claim 1, wherein the first gain is a reduced gain for the receiver determined based on an AGC algorithm.

4. The method of claim 1, wherein the second gain is a backoff gain for the receiver determined according to the power level of the signal exceeding the configured AGC threshold without the signal including an indication of valid packet reception.

5. The method of claim 1, wherein identifying the signal received on the wireless medium as an interference signal includes:
determining an estimated interference power level for the identified interference signal;
calculating a value for the second gain based on the estimated interference power level; and
lowering the receiver gain from a maximum gain value to the calculated value for the second gain.

6. The method of claim 1, wherein the receiver returns to listening on the wireless medium using the first gain in response to an expiration of the configured duration of the monitoring period without an indication of packet arrival.

7. The method of claim 1, further comprising:
monitoring the wireless medium for the configured duration of the monitoring period, using the receiver configured with the second gain; and
stopping the monitoring in response to expiration of the configured duration, or detection of a valid packet on the wireless medium.

8. The method of claim 1, wherein adjusting the gain information of the receiver comprises reducing the first gain by an amount equal to a configured desensitization offset to obtain the second gain.

9. The method of claim 8, wherein the configured desensitization offset is 6 decibels (dB).

10. The method of claim 8, wherein the configured desensitization offset comprises a dynamically determined value based on one or more signals received by the wireless device.

11. The method of claim 1, wherein configuring the second gain maintains an interference power level of the interference signal below the configured AGC threshold.

12. The method of claim 1, wherein configuring the second gain for the receiver includes:
monitoring the wireless medium for packet arrival based on the receiver maintaining the second gain until expiration of a timer running from a start time of the monitoring, wherein expiration of the timer corresponds to expiration of the configuration duration of the monitoring period.

13. The method of claim 1, further comprising maintaining the second gain for the receiver until expiration of the configured duration based on a timer running from a start time of the monitoring period, or until detection of the indication of packet arrival.

14. The method of claim 13, further comprising resetting the gain information of the receiver from the second gain to the first gain in response to the expiration of the configured duration.

15. The method of claim 14, wherein the configured duration is a predetermined time duration based on a maximum Transmission Opportunity (TXOP) value configured for communications associated with the wireless device.

16. The method of claim 1, wherein detecting the indication of packet arrival is based on detecting a packet preamble sequence within the configured duration of the monitoring period.

17. The method of claim 16, wherein the packet preamble sequence is a Short Training Field (STF) of a valid packet.

18. A wireless device operating in a wireless network, comprising:
a receiver configured for reception of one or more packets transmitted on a wireless medium, the receiver including a receive chain with an automatic gain control (AGC);
a processor, communicatively coupled to the receiver; and
one or more memory banks, communicatively coupled to the processor and storing processor-readable instructions that, when executed by the processor, cause the processor to:
configure a first gain for the receiver to listen on the wireless medium;
identify a signal received on the wireless medium as an interference signal, wherein the signal is received using the first gain, and wherein the signal is identified as an interference signal based on a power level of the signal exceeding a configured AGC threshold without the signal including an indication of valid packet reception;
configure, in response to the identification of the interference signal, a second gain for the receiver that is less than the first gain to thereby desense the receiver;
detect an indication of packet arrival using the second gain, wherein the indication of packet arrival is detected within a configured duration of a monitoring period corresponding to the receiver using the second gain;
in response to the indication of packet arrival, adjust gain information of the receiver to obtain a third gain less than the second gain; and
receive, using the receiver configured with the third gain, a packet corresponding to the indication of packet arrival.

19. The wireless device of claim 18, wherein the processor-readable instructions further cause the processor to:
start listening on the wireless medium with a maximum gain for the receiver before configuring the receiver to the first gain.

20. The wireless device of claim 18, wherein the first gain is a reduced gain for the receiver determined based on an AGC algorithm corresponding to the AGC.
